(19) United States
(12) Patent Application Publication
(10) Pub. No.: US 2016/0065789 A1
(43) Pub. Date: Mar. 3, 2016

(54) IMAGE PROCESSING METHOD, IMAGE FORMING METHOD, IMAGE PROCESSING APPARATUS, AND IMAGE FORMING APPARATUS

(71) Applicant: KONICA MINOLTA, INC., Tokyo (JP)

(72) Inventor: Syunji KAMEI, Tokyo (JP)

(73) Assignee: KONICA MINOLTA, INC., Tokyo (JP)

(21) Appl. No.: 14/841,286

(22) Filed: Aug. 31, 2015

(30) Foreign Application Priority Data
Sep. 2, 2014 (JP) 2014-178304

(51) Int. Cl. H04N 1/50; H04N 1/64; H04N 1/41; H04N 1/00

(52) U.S. Cl. CPC H04N 1/502; H04N 1/00339; H04N 1/64; H04N 1/41; H04N 2201/0094; H04N 2201/3283; H04N 2201/3294; H04N 2201/3256

(57) ABSTRACT

An image processing apparatus for processing image data in which color data and attribute data of each pixel are arranged in a dot sequential format, includes an arrangement converting section which separates the color data and the attribute data in the image data and converts arrangement into a face sequential format of a color data group and an attribute data group; and a compressing section which lossily compresses the color data group and losslessly compresses the attribute data group.

The present application claims the priority under the Paris Convention based on Japanese Patent Application No. 2014-178304 filed on Sep. 2, 2014, in accordance with the provisions in Article 119 in the United States Patent Law.

### BACKGROUND OF THE INVENTION

1. Field of the Invention

The present invention relates to an image processing method, an image forming method, an image processing system, and an image forming apparatus. In particular, the present invention relates to a technique to handle image data of a dot sequential format at high speed without increasing the cost of hardware in image processing and image formation.

2. Description of Related Art

As an image forming apparatus, there exist a scanner, a printer, a copier, a facsimile machine, a composite machine (MFP: Multifunction Peripheral) equipped with these functions by a single set, and the like. These image forming apparatuses are required to store various kinds of data for each job. Examples of various kinds of data include scan data acquired by scanning, print data (image data before being processed by RIP (Raster Image Processor)) transmitted from external devices, and image data (image data after having been processed by RIP) rasterized as bit map data. Accordingly, in such an image forming apparatus, a hard disk drive unit (HDD; Hard Disk Drive) tends to be mounted as a nonvolatile storage section for storing a large amount of image data.

Further, in recent years, image data handled by an image forming apparatus have been increasing in terms of each of the number of data and an amount of data. Then, at the time of storing image data in the above-mentioned HDD, generally, the image data are stored after having been made in a compressed state.

In a commercial printing system, not only a conventional offset printing apparatus, but also an image forming apparatus of an electrophotographying type has been used. Herein, as compared with a printing system in a general office, such a commercial printing system is characterized in that a data size of print data is extremely large. Therefore, print data having been input are configured to be stored once in a HDD which is cheap and has a large capacity. Subsequently, the print data are converted into image data by RIP processing, and the converted image data are used for image formation. At the time of the RIP processing, the RIP processing is performed for print data while reading out print data from the HDD.

Incidentally, in a large-sized image forming apparatus such as a commercial printing apparatus, the large number of paper sheets (staying paper sheets) exists simultaneously in the image forming apparatus during a period after having been subjected to image formation until having been output to the outside. In the case of such an image forming apparatus with the large number of staying paper sheets, in many cases, the image forming apparatus is configured to store image data converted from pint data by RIP processing once in a HDD. Accordingly, a read-out speed at the time of accessing the HDD becomes a factor to determine the productivity of image formation. In other words, an access speed for the HDD becomes “rate limiting” of the productivity of the image forming apparatus.

In order to realize further performance improvement with such constitution, it may be considered to take a measure in association with hardware, such as utilization of a HDD with a RAID constitution (increase of the number of HDDs) so as to improve the HDD performance. Further, also, it may be considered to take a measure in association with hardware, such as reduction of an amount of data to be accessed to a HDD. Furthermore, also, it may be considered to take a measure in association with hardware, such as reduction of an amount of data to be accessed to a HDD and application of hardware so as to perform processing for the reduction.

However, there has been a problem that a solution with a measure in association with hardware directly leads to an increase in a development cost and a production cost.

On the other hand, in an image forming apparatus in a commercial printing system required to have rapidity, in order to increase print productivity, there exists a system configured to process image data in units of a band, not in units of a page. In this case, in order to perform RIP processing in units of a band, image data are needed to be such that color data and attribute data of each pixel in the image data are arranged in a dot sequential format.

In order to reduce hardware cost, some of image forming apparatuses configured to process image data of such a dot sequential format adopt a constitution to compress only color data contained in image data by hardware.

FIG. 9 is a flow chart which shows a processing procedure in the above conventional image forming apparatuses. Herein, in print data received from an apparatus such as a controller (Step S11 in FIG. 9), data corresponding in amount to one page are divided into X band units (X is an integer). Successively, RIP processing is executed for each pint data divided in units of a band so as to produce image data (color data and attribute data) (Step S12, 13, and 14 in FIG. 8).

In response to the RIP processing, color data in units of a band are lossily compressed (irreversibly compressed) (Step S14 in FIG. 9). Successively, at a time when all the RIP processing in units of a band has been completed (Step S15 in FIG. 9), encryption processing is executed for the image data corresponding in amount to one page (Step S16 in FIG. 8). Then, the image data applied with the encryption processing are stored in a HDD (Step S17 in FIG. 8). Further, the image data are read out from the HDD (Step S21 in FIG. 9), decryption processing is executed for the image data so as to cancel the encryption state (Step S22 in FIG. 9).

Successively, extension processing is executed for the image data released from the encryption state so as to cancel the compression state (Step S23 in FIG. 9). In this way, image formation is executed by using the decrypted and extended image data (Step S24 in FIG. 9). Incidentally, Japanese Unexamined Patent Publication No. 2010-245976 has made various proposals for problems in such an image forming apparatus.

### SUMMARY OF THE INVENTION

Japanese Unexamined Patent Publication No. 2010-245976 discloses a technique to separate image data into image blocks and non-image blocks based on attribute data and to compress them appropriately so as to suppress image deterioration. Further, this document discloses a technique to losslessly compress (reversibly compress) attribute data.

However, the above document is silent on the matter that in the case where color date and attribute data are arranged in a dot sequential format, the color date and the attribute data are handled separately from each other so as to be compressed appropriately with good efficiency.

An object of the present invention is to realize a technique to handle image data of a dot sequential format at high speed without increasing the cost of hardware.

(1) An image processing apparatus which reflects one aspect of the present invention is an image processing apparatus for processing image data in which color data and attribute data of each pixel are arranged in a dot sequential format, including an arrangement converting section which separates the color data and the attribute data in the image data and converts arrangement into a face sequential format of a color data group and an attribute data group, and a compressing section which lossily compresses the color data group and losslessly compresses the attribute data group.

(2) In the above (1), the image processing apparatus further includes a RIP processing section which executes Rip processing for image data before RIP (not applied with the RIP processing), the RIP processing section executes the RIP processing in units of a band for the image data which correspond in amount to one page and are divided into multiple bands, and the compressing section repeats lossy compression executed in units of a band for the color data group corresponding in amount to one page and losslessly compresses the attribute data group which is converted in terms of arrangement and corresponds in amount to one page.

(3) In the above (1) to (2), the image processing apparatus further includes a storage section to store data and a control section to control action of each section, and the control section controls such that color data group storage processing to store the lossily-compressed color data group in the storage section and attribute data group compression processing to losslessly compress the attribute data group by the compressing section are executed in parallel to each other.
(4) In the above (1) to (3), the image processing apparatus further includes a storage section to store data and a control section to control action of each section, and the control section controls such that color data group storage processing to store the lossily-compressed color data group in the storage section and attribute data group storage processing to store the losslessly-compressed attribute data group in the storage section are executed in respective different timings from each other.
(5) In the above (1) to (4), the image processing apparatus further includes a storage section to store data, an extending section which lossily extends the lossily compressed color data group and losslessly extends the losslessly compressed attribute data group, and a control section to control action of each section, and in the case where the lossily-compressed color data group and the losslessly-compressed attribute data group are stored with a face sequential format in the storage section, the control section controls such that color data group read-out processing to read out the lossily-compressed color data group from the storage section and attribute data group read-out processing to read out the losslessly-compressed attribute data group from the storage section are executed in respective different timings, and the control section controls the arrangement converting section to convert the arrangement of each of the read-out color data group and the read-out attribute data group into a dot sequential format.
(6) In the above (1) to (5), the image processing apparatus further includes a storage section to store data, an extending section which lossily extends the lossily compressed color data group and losslessly extends the losslessly compressed attribute data group, and a control section to control action of each section, and the control section controls such that color data group read-out processing to read out the lossily-compressed color data group from the storage section and attribute data group extension processing to losslessly extend the losslessly-compressed attribute data group read out from the storage section by the extending section are executed in parallel to each other.
(7) In the above (1) to (6), the image processing apparatus further includes an encrypting section to encrypt data and a control section to control action of each section, and the control section controls such that the color data group is encrypted by the encrypting section after having been lossily compressed by the compressing section and the attribute data group is encrypted by the encrypting section after having been losslessly compressed by the compressing section.
(8) In the above (7), the image processing apparatus further includes a decrypting section to decrypt encrypted data and a control section to control action of each section, and the control section controls such that the color data group is decrypted by the decrypting section before being lossily extended by the extending section and the attribute data group is decrypted by the decrypting section before being losslessly extended by the extending section.
(9) An image forming apparatus which reflects one aspect of the present invention includes the image processing apparatus of the (1) to (4), an extending section which lossily extends the lossily-compressed color data group and losslessly extends the losslessly-compressed attribute data group; a storage section which stores data; a control section which controls operation of each section; and an image forming section which forms an image based on the image data of a dot sequential format; and the control section controls so as to store lossily-compressed color data group and losslessly-compressed attribute data group with a face sequential format in the storage section, to read out the color data group and the attribute data group from the storage section, to lossily extend the read-out color data group by the extending section and losslessly extend the read-out attribute data group by the extending section, to convert arrangement of each of the lossily-extended color data group and the losslessly-extended attribute data group into a dot sequential format by the arrangement converting section, and to form an image based on the image data converted in arrangement into the dot sequential format.
(10) An image forming apparatus which reflects one aspect of the present invention includes the image processing apparatus of the (5) to (8) and an image forming section to form an image based on image data converted in arrangement into a dot sequential format.

### BRIEF DESCRIPTION OF THE DRAWINGS

FIG. 1 is a constitution diagram showing a constitution of an apparatus in an embodiment of the present invention.

FIG. 2 is a flow chart showing operation in an embodiment of the present invention.

FIG. 3 is an explanatory drawing showing a state of image data used in an embodiment of the present invention.

FIG. 4 is an explanatory drawing showing a state of image data used in an embodiment of the present invention.

FIG. 5 is an explanatory drawing showing a state of image data used in an embodiment of the present invention.

FIG. 6 is a flow chart showing operation in an embodiment of the present invention.

FIG. 7 is a flow chart showing operation in an embodiment of the present invention.

FIG. 8 is a flow chart showing operation in an embodiment of the present invention.

FIG. 9 is a flow chart showing operation in a conventional image forming apparatus.

### DETAILED DESCRIPTION OF THE PREFERRED EMBODIMENT

Hereinafter, with reference to the drawings, description will be given in detail to a mode (hereafter, referred to embodiment) for implementing the present invention. Herein, description is given to an image forming apparatus 100 as a specific example which can operate as a copier, a scanner, a printer, etc., and has a function to store data.

### [A] Constitution of an Image Forming Apparatus:

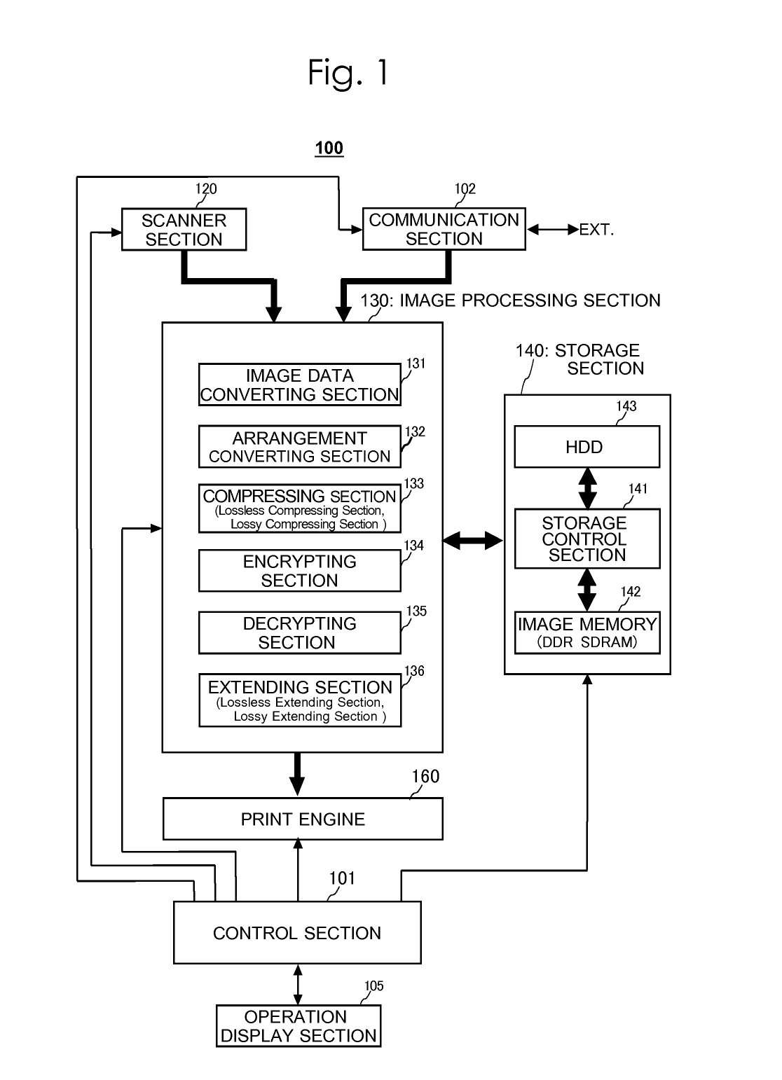

The image forming apparatus 100 shown in FIG. 1 is constituted so as to include a control section 101, a communication section 102, an operation display section 105, a scanner section 120, an image processing section 130, a storage section 140, and a print engine 160.

The control section 101 is constituted to include a CPU (Central Processing Unit) etc., and is configured to control respective sections in the image forming apparatus 100. The communication section 102 is configured to communicate with other apparatuses via various networks and to receive print data (image data before RIP) from other apparatuses. The operation display section 105 is constituted to include a liquid crystal display section and a touch panel, and is configured to allow a user to input an operation.

The scanner section 120 is configured to read documents optically with a light source and a reading element and to produce image data. The image processing section 130 is configured to execute various kinds of image processing, such as RIP processing and compression/extension processing. The storage section 140 is configured to store image data etc. which are handled by the image forming apparatus 100. The print engine 160 is configured to perform image formation with an electrophotographying system etc. based on image data.

The image processing section 130 is constituted to include an image data converting section 131, an arrangement converting section 132, a compressing section 133, an encrypting section 134, a decrypting section 135, and an extending section 136.

Here, the image data converting section 131 is configured to rasterize print data (image data before RIP) described with a page description language by RIP (Raster Image Processor) processing, thereby producing image data of a bit map format. The arrangement converting section 132 is configured to separate color data and attribute data from image data, to convert the respective arrangements of the color data and the attribute data into a color data group and an attribute data group in a face sequential format respectively, and to convert the respective arrangements of the color data group and the attribute data group from the face sequential format to a dot sequential format.

The compressing section 133 is configured to lossily compress a color data group in a lossily compressing section and to losslessly compress an attribute data group in a losslessly compressing section. The encrypting section 134 is configured to encrypt data by using various kinds of encrypting algorithms. The decrypting section 135 is configured to decrypt the encrypted data. The extending section 136 is configured to lossily extend a compressed color data group in a lossily extending section and to losslessly extend a compressed attribute data group in a losslessly extending section.

Herein, when storage processing is executed on one side of later-mentioned parallel processing and the compressing section 133 executes lossless compression on another side of the parallel processing, the load of the CPU in the storage processing is small. For this reason, it is possible for the CPU to perform the lossless compression in accordance with software. Therefore, it is possible to cope with the lossless compression by the software without providing hardware used only for the lossless compression.

The storage section 140 is constituted to include a storage control section 141, an image memory 142 as a volatile storage section, and a HDD 143.

Herein, the storage control section 141 is configured to control storage of data in the storage section 140. The image memory 142 is a volatile storage section, and stores the image data of a page for image formation in a semiconductor memory, such as DDR_SDRAM. The HDD 143 stores a large amount of image data as a nonvolatile storage section.

In the embodiment shown in FIG. 1, a constitution of the image forming apparatus 100 which incorporates an image processing apparatus 130 therein is shown as a specific example. However, the image processing apparatus 130 may exist independently from the image forming apparatus 100 as an image processing apparatus of a single body. Further, the image processing apparatus 130 may exist as an image processing apparatus incorporated in other apparatus.

With regard to encryption processing, decryption processing, compression processing, and extension processing, it is possible to use various kinds of known methods. For this reason, with regard to the encryption processing, the decryption processing, the compression processing, and the extension processing, methods should not be limited to a certain specific method.

### [B] Operation (Storage Processing) in the Image Forming Apparatus:

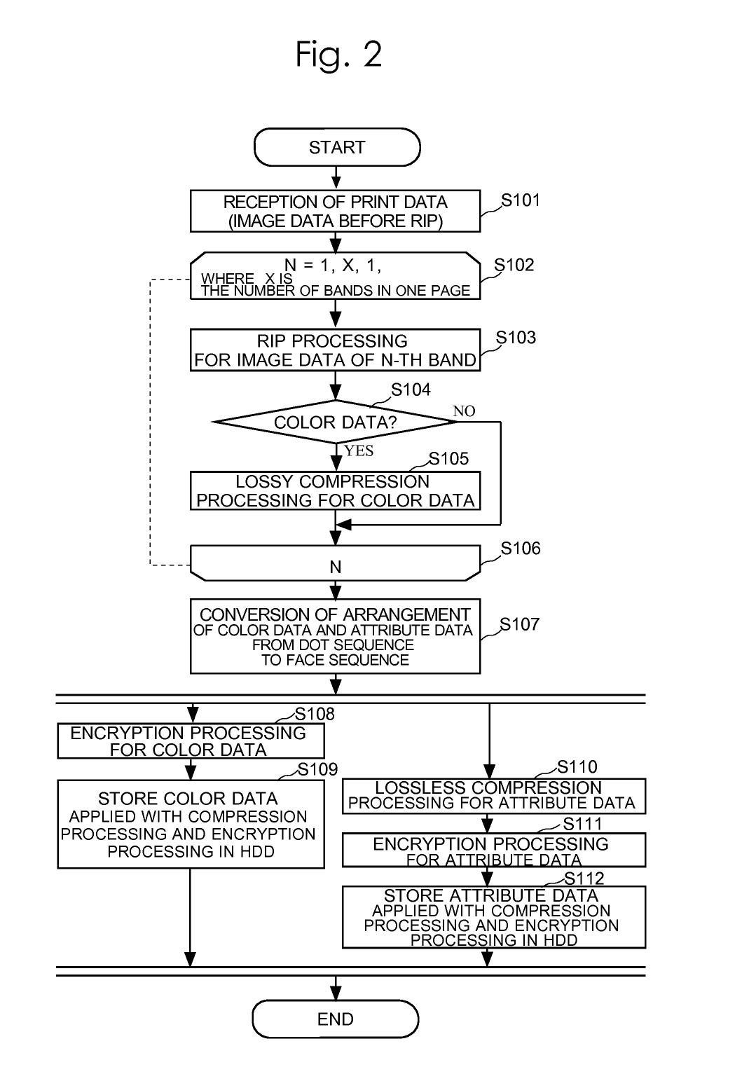

Herein, description is given to the first half of the operation of image formation in the present embodiment. In the following description, description on general operation as the image forming apparatus 100 is omitted, and description is given with reference to a flow chart shown in FIG. 2 while focusing on a portion becoming as a characterizing portion of the present embodiment.

The image processing section 130 receives print data (image data before RIP) transmitted from an external device via the communication section 102 (Step S101 in FIG. 2). These print data are described with page description languages etc. Accordingly, later-mentioned RIP processing is needed for the print data.

Herein, print data and image data in this embodiment are constituted with a dot sequential format. The dot sequential format means a format that color data and attribute data are arranged alternately for each pixel.

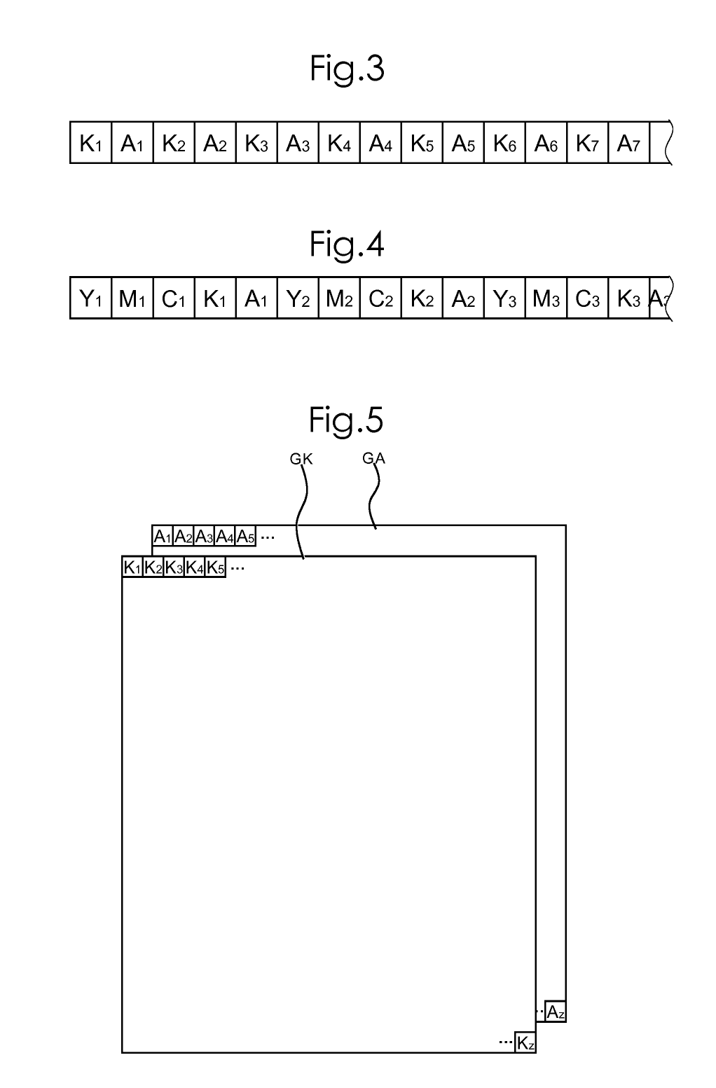

As shown in FIG. 3, in monochromatic image data of the dot sequential format, the color data Kn (K1, K2, . . . ) of each pixel and the attribute data An (A1, A2, . . . ) of each pixel are arranged alternately for each pixel.

Further, as shown in FIG. 4, in multicolor color image data of the dot sequential format, the respective color data Yn, Mn, Cn, Kn of colors of each pixel and the attribute data An of each pixel are arranged alternately for each pixel. Herein, “n” represents a pixel number. Further, the color data represent a pixel value of one of colors of each pixel. Furthermore, the attribute data represent the attribute (a kind, such as a character, a binary image, and a multiple value gradation image) of each pixel.

Further, in this embodiment, at the time of storing image data, the arrangement of the image data of the dot sequential format are converted into image data of a face sequential format. Herein, the face sequential format means a format that color data (face data) corresponding in amount to one page and attribute data (face data) corresponding in amount to one page are arranged alternately.

As shown in FIG. 5, in the case of monochromatic image data of the face sequential format, a color data group GK of the color data Kn of each pixel corresponding in amount to one page (one face) and an attribute data group GA of the attribute data An of each pixel corresponding in amount to one page (one face) are arranged for each page. In the case of multicolor image data of the face sequential format, if the multicolor image data are the multicolor image data as shown in FIG. 4, five faces in total of four faces of color data groups Y, M, C, and K and one face of an attribute data group A are arranged.

The print data received in the image processing section 130 are divided into units of a band, and are sent to the image data converting section 131. The print data divided into units of a band are rasterized by RIP processing in the image data converting section 131 and are converted into image data of a bit map format (Steps S102 and S103 in FIG. 2).

At this time, the color data are lossily compressed by the compressing section 133 (Step S105 in FIG. 2). In the case where one page is divided into X bands, the above RIP processing and the lossy compression processing for the color data are executed repeatedly in units of a band from the first band to the X-th band (Step S102 to S106 in FIG. 2).

Successively, the arrangement of the image data is converted by the arrangement converting section 132 such that the image data of the dot sequential format (refer to FIG. 3 and FIG. 4) become a color data group and attribute data group of the face sequential format (refer to FIG. 5) (Step S107 in FIG. 2).

Subsequently, the encryption processing for the color data group is executed by the encrypting section 134 (color data group encryption processing: Step S108 in FIG. 2). The color data group having been applied with the compression processing and the encryption processing as mentioned above are stored in the HDD 143 by the storage processing (color data group storage processing: Step S109 in FIG. 2).

Further, when the above color data group encryption processing and color data group storage processing are performed, the following attribute data group compression processing and attribute data group storage processing are executed as parallel processing. That is, the attribute data group is losslessly compressed by the compressing section 133 (attribute data group compression processing: Step S110 in FIG. 2). Subsequently, the compressed attribute data group is applied with the encryption processing by the encrypting section 134 (Step S111 in FIG. 2). The attribute data group applied with the compression processing and the encryption processing as mentioned above is stored in the HDD 143 by the storage processing (attribute data group storage processing: Step S112 in FIG. 2). That is, in the parallel processing, Steps S108 to S109 are executed as processing on one side of the parallel processing, and Steps S110 to S112 are performed as processing on another side.

Further, in the above-mentioned parallel processing, it is more preferable that the color data group storage processing (Step S109 in FIG. 2) to store the lossily compressed color data group in the HDD 143 and the attribute data group compression processing (Step S110 in FIG. 2) to losslessly compress the attribute data group by the compressing section 133 are executed in parallel to each other such that their respective timings overlap with each other. That is, the timing of the color data group storage processing is made to overlap with the timing of the attribute data group compression processing.

In this case, during execution of the color data group storage processing (Step S109 in FIG. 2), the load of the CPU of the control section 101 is small. For this reason, it becomes possible to assign the power of a processor sufficiently to the attribute data group compression processing (Step S110 in FIG. 2). Therefore, it becomes possible to perform the lossless compression processing promptly. That is, since all the data (both the color data and the attribute data) do not concentrate on each of the storage processing and the compression processing, the storage processing and the compression processing can be executed promptly without any waste. Accordingly, it becomes possible to handle the image data of the dot sequential format at high speed without increasing the cost of hardware.

Similarly, in the parallel processing, it is preferable that the color data group storage processing (Step S109 in FIG. 2) to store the lossily compressed color data group in the HDD 143 and the attribute data group encryption processing (Step S111 in FIG. 2) to encrypt the attribute data group by the encrypting section 134 are executed in parallel to each other such that their respective timings overlap with each other.

In this case, during execution of the color data group storage processing (Step S109 in FIG. 2), the load of the CPU of the control section 101 is small. For this reason, it becomes possible to assign the power of a processor sufficiently to the attribute data group encryption processing (Step S111 in FIG. 2), and it becomes possible to perform the encryption processing promptly. That is, since all the data (both the color data and the attribute data) do not concentrate on each of the storage processing and the encryption processing, the storage processing and the encryption processing can be executed promptly without any waste. Accordingly, it becomes possible to handle the image data of the dot sequential format at high speed without increasing the cost of hardware.

Further, in the parallel processing, it is preferable that the color data group storage processing (Step S109 in FIG. 2) to store the lossily compressed color data group in the HDD 143 and the attribute data group storage processing (Step S112 in FIG. 2) to store the losslessly compressed attribute data group in the HDD 143 are executed in parallel to each other such that their respective timings are different from each other.

In this case, the timing of the color data group storage processing (Step S109 in FIG. 2) is made different from the timing of the attribute data group storage processing (Step S112 in FIG. 2), whereby access to the HDD 143 is dispersed. That is, it becomes possible to solve the problem of rate limiting due to the HDD access concentration which had occurred conventionally. Further, since all the data (both the color data and the attribute data) do not concentrate on the storage processing, the storage processing can be executed promptly without any waste. Accordingly, it becomes possible to handle the image data of the dot sequential format at high speed without increasing the cost of hardware.

Further, as mentioned above, during execution of the color data group storage processing (Step 5109 in FIG. 2), the attribute data group compression processing (Step S110 in FIG. 2) or the attribute data group encryption processing (Step S111 in FIG. 2) is executed, whereby the two processes of the storage processing (Steps S109 and S112 in FIG. 2) executed separately are not likely to cause uselessness as a result.

Further, in the above specific example, the color data group is encrypted after being lossily compressed, and the attribute data group is encrypted after being losslessly compressed. Herein, if encryption is executed prior to compression, the value of data is rewritten, whereby continuity is no longer maintained. As a result, good efficient compression is not executed. Namely, as mentioned above, the encryption processing of the color data group and the encryption processing of the attribute data group are executed after respective compression, whereby the color data group and the attribute data group have the continuity of data in a given range respectively. Accordingly, good efficient compression can be attained. As a result, it becomes possible to handle the image data of the dot sequential format at high speed without increasing the cost of hardware.

### [C] Operation (Read-Out and Image Formation Processing) in the Image Forming Apparatus:

Herein, description is given to the latter half of the operation of image formation in the present embodiment. In the following description, description on general operation as the image forming apparatus 100 is omitted, and description is given with reference to a flow chart shown in FIG. 2 while focusing on a portion becoming as a characterizing portion of the present embodiment.

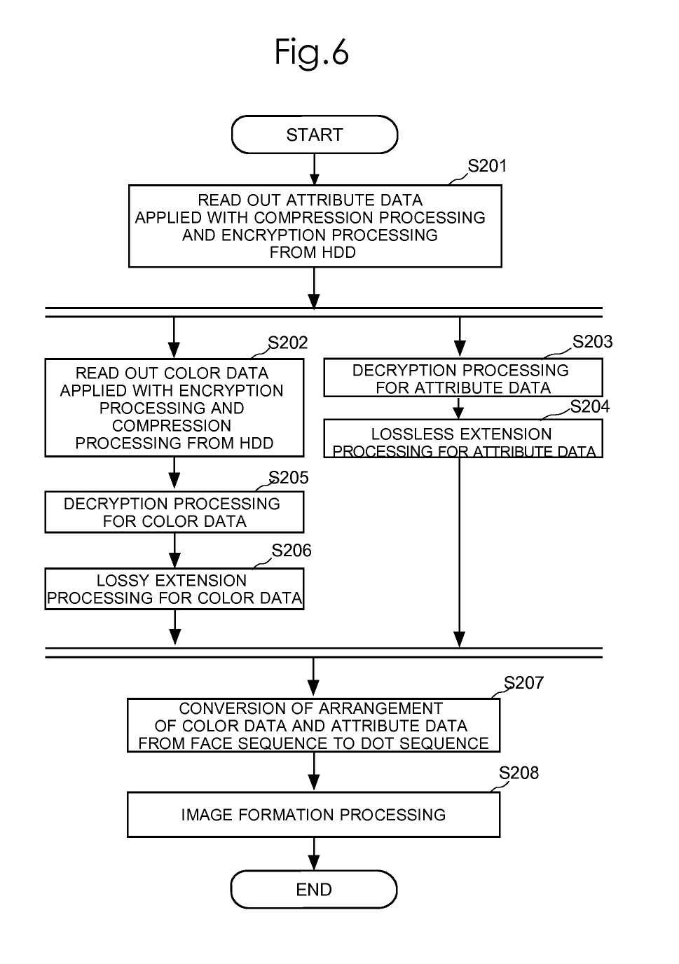

First, the attribute data group applied with the lossless compression processing and the encryption processing is read out from the HDD 143 (Step S201 in FIG. 6). The read-out attribute data group is stored temporarily in the image memory 142 which is a volatile storage section. Then, the color data group applied with the lossy compression processing and the encryption processing is read out from the HDD 143 (color data group read-out processing: Step S202 in FIG. 6).

The read-out color data group is applied with decryption processing by the decrypting section 135 so as to be released from the encryption state (color data group decryption processing: Step S205 in FIG. 6). The color data group released from the encryption state is applied with the lossy extension processing by the extending section 136 so as to be leased from the compression state (color data group extension processing: Step S206 in FIG. 6). Further, when the above color data group read-out processing, color data group decryption processing, and color data group extension processing are executed, as parallel processing, attribute data group decryption processing and attribute data group extension processing are executed. That is, the read-out attribute data group is applied with decryption processing by the decrypting section 135 so as to be released from the encryption state (attribute data group decryption processing: Step S203 in FIG. 6). Then, the attribute data group released from the encryption state is applied with the lossless extension processing by the extending section 136 so as to be released from the compression state (attribute data group extension processing: Step S204 in FIG. 6).

Further, in the parallel processing, it is preferable that the color data group read-out processing (Step S202 in FIG. 6) to read out the color data group from the HDD 143 and the attribute data group extension processing (Step S204 in FIG. 6) to losslessly extend the attribute data group by the extending section 136 are executed in parallel to each other such that their respective timings overlap with each other. In this case, during execution of the color data group read-out processing (Step S202 in FIG. 6), the load of the CPU of the control section 101 is small. For this reason, it becomes possible to assign the power of a processor sufficiently to the attribute data group extension processing (Step S204 in FIG. 6), and it becomes possible to perform the lossless extension processing promptly.

That is, since all the data (both the color data and the attribute data) do not concentrate on each of the read-out processing and the extension processing, the read-out processing and the extension processing can be executed promptly without any waste. Accordingly, it becomes possible to handle the image data of the dot sequential format at high speed without increasing the cost of hardware.

Similarly, in the parallel processing, it is preferable that the color data group read-out processing (Step S202 in FIG. 6) to read out the color data group from the HDD 143 and the attribute data group decryption processing (Step S203 in FIG. 6) to decrypt the attribute data group by the decrypting section 135 are executed in parallel to each other such that their respective timings overlap with each other. In this case, during execution of the color data group read-out processing (Step S202 in FIG. 6), the load of the CPU of the control section 101 is small. For this reason, it becomes possible to assign the power of a processor sufficiently to the attribute data group decryption processing (Step S203 in FIG. 6). Therefore, it becomes possible to perform the decryption processing promptly. That is, since all the data (both the color data and the attribute data) do not concentrate on each of the read-out processing and the decryption processing, the read-out processing and the decryption processing can be executed promptly without any waste. Accordingly, it becomes possible to handle the image data of the dot sequential format at high speed without increasing the cost of hardware.

Further, in the processing in this embodiment, it is preferable that the attribute data group read-out processing (Step S201 in FIG. 6) to read out the attribute data group from the HDD 143 and the color data group read-out processing (Step S202 in FIG. 6) to read out the color data group from the HDD 143 are executed such that their respective timings are different from each other. In this case, the timing of the attribute data group read-out processing (Step S201 in FIG. 6) is made different from the timing of the color data group read-out processing (Step S202 in FIG. 6), whereby access to the HDD 143 is dispersed. That is, it becomes possible to solve the problem of rate limiting due to the HDD access concentration which had occurred conventionally. Further, since all the data (both the color data and the attribute data) do not concentrate on the read-out processing, the read-out processing can be executed promptly without any waste. Accordingly, it becomes possible to handle the image data of the dot sequential format at high speed without increasing the cost of hardware.

Further, as mentioned above, during execution of the color data group read-out processing (Step S202 in FIG. 6), the attribute data group extension processing (Step S204 in FIG. 6) or the attribute data group decryption processing (Step S203 in FIG. 6) is executed, whereby the two processes of the read-out processing (Steps S201 and S202 in FIG. 6) executed separately are not likely to cause uselessness as a result.

Further, in the above specific example, since the data group is encrypted after being compressed, the color data group is decrypted before being lossily extended, and the attribute data group is decrypted before being losslessly extended. In this way, each of the decrypting operation of the color data group and the decrypting operation of the attribute data group is executed before the extending operation. Accordingly, it becomes possible to extend the compressed color data group and the compressed attribute data in a good efficient state after the decryption operation. In this case, the color data group is compressed before the encryption processing, and the attribute data group is compressed before the encryption processing. Accordingly, the color data group and the attribute data group in a state of having the continuity of data within a given range can be compressed with good efficiency. That is, since the data size at the time of decryption is also controlled, it becomes possible to execute high speed processing without increasing the cost of hardware.

Further, in the above specific example, at the time of processing image data arranged in the dot sequential format, the lossily compressed color data group and the losslessly compressed attribute data group are stored with the face sequential format in a HDD 143. Subsequently, the color data group and the attribute data group are read out from the HDD 143. Then, the read-out color data group is lossily extended, and the read-out attribute data group is losslessly extended. Successively, the lossily extended color data group and the losslessly extended attribute data group are converted in arrangement to the dot sequential format. Thereafter, an image is formed based on the image data converted in arrangement to the dot sequential format. Thus, the image data of the dot sequential format are processed by arrangement conversion, compression, storage, extension, and arrangement conversion. Accordingly, it becomes possible to perform image formation while handling the image data of the dot sequential format at high speed without increasing the cost of hardware.

### [D] Operation (Storage (2)) in the Image Forming Apparatus:

In the above-described “[B] Operation (storage processing) in the image forming apparatus”, the color data group and the attribute data group are stored in the HDD 143 after being applied with the encryption processing. However, the present invention should not be limited to the above specific example. For example, in the case where image data not having confidentiality are handled, or in the case where a possibility that image data flow out from the image forming apparatus 100 is very small, the encryption processing is unnecessary.

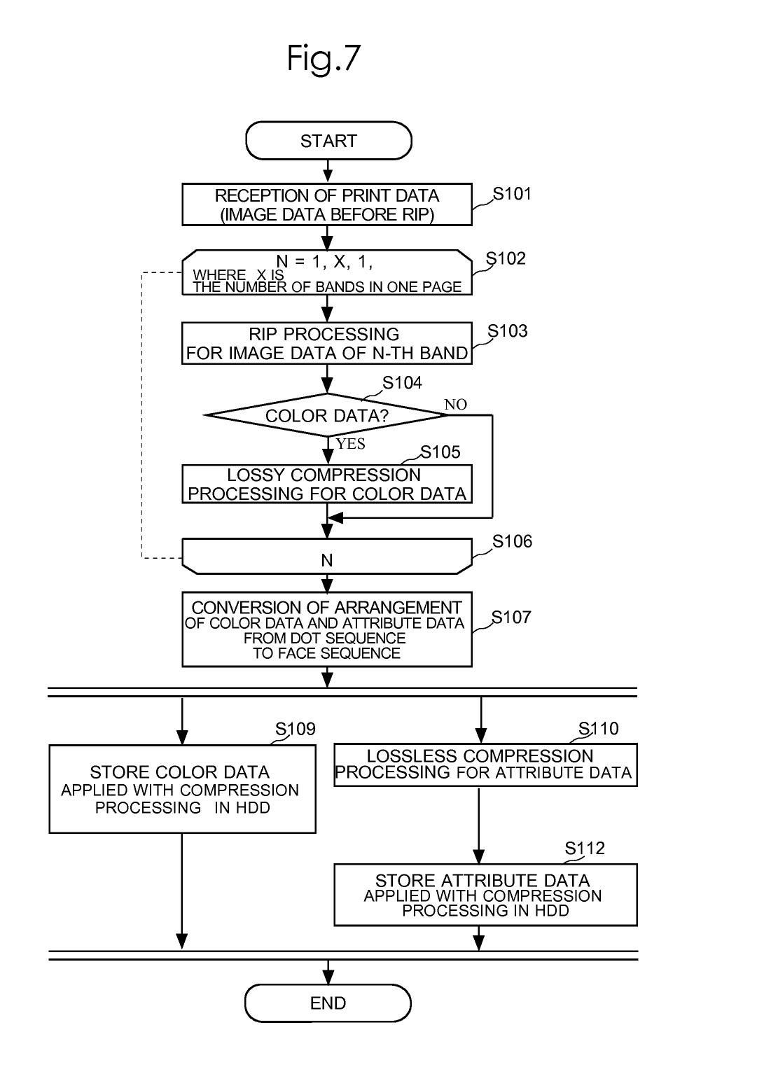

In such a case, the respective steps described in the flow chart shown in FIG. 2 may be modified as shown in FIG. 7. Herein, in FIG. 2 and FIG. 7, the same processing content is attached with the same step number, whereby the duplicate description is omitted. In FIG. 7, the color data group encryption processing and the attribute data encryption processing are omitted. Further, in FIG. 7, the respective contents of other items in the processing and the processing order are the same as those in the case of FIG. 2.

In parallel processing in this case, the color data group storage processing (Step S109 in FIG. 7) to store the lossily compressed color data group in the HDD 143 and the attribute data group compression processing (Step S110 in FIG. 7) to losslessly compress the attribute data group by the compressing section 133 are executed in parallel to each other such that their respective timings overlap with each other. As a result, since all the data (both the color data and the attribute data) do not concentrate on each of the storage processing and the compression processing, the storage processing and the compression processing can be executed promptly without any waste. Accordingly, it becomes possible to handle the image data of the dot sequential format at high speed without increasing the cost of hardware.

Further, in parallel processing in this case, the color data group storage processing (Step S109 in FIG. 7) to store the lossily compressed color data group in the HDD 143 and the attribute data group storage processing (Step 5112 in FIG. 7) to store the losslessly compressed attribute data group in the HDD 143 are executed in parallel to each other such that their respective timings are different from each other. In this way, their respective timings of the two processes of the storage processing are made different from each other, whereby access to the HDD 143 is dispersed. That is, it becomes possible to solve the problem of rate limiting due to the HDD access concentration which had occurred conventionally. Further, since all the data (both the color data and the attribute data) do not concentrate on the storage processing, the storage processing can be executed promptly without any waste. Accordingly, it becomes possible to handle the image data of the dot sequential format at high speed, without increasing the cost of hardware.

### [E] Operation (Read-Out and Image Formation Processing (2)) in the Image Forming Apparatus:

In the above-described “[C] Operation (read-out and image formation processing) in the image forming apparatus”, after the color data group and the attribute data group are applied with the decryption processing, extension processing is executed. However, the present invention should not be limited to the above specific example. For example, in the case where image data not having confidentiality are handled, or in the case where a possibility that image data flow out from the image forming apparatus 100 is very small, if the encryption processing is omitted, the decryption processing is also unnecessary.

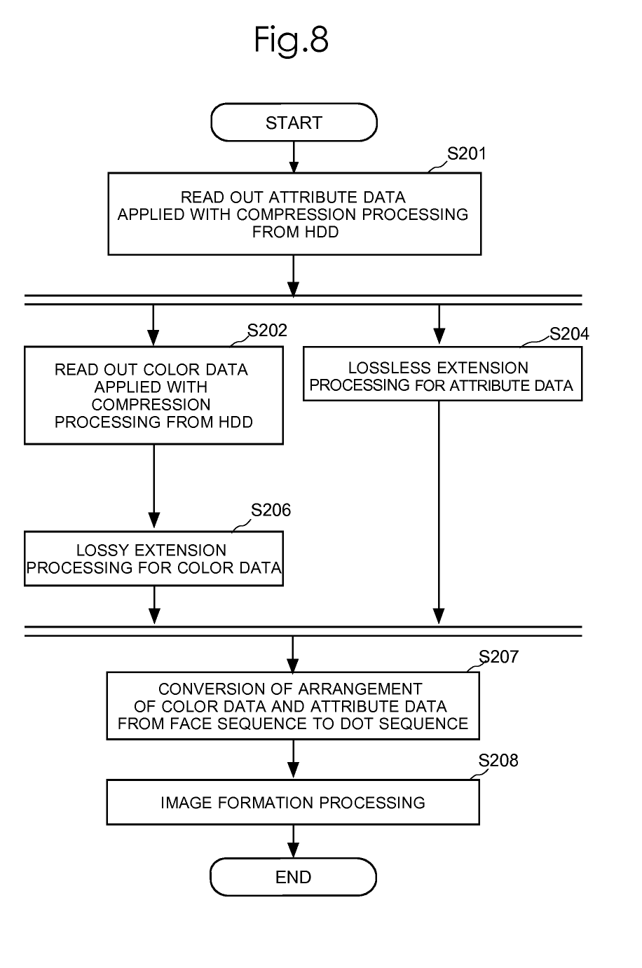

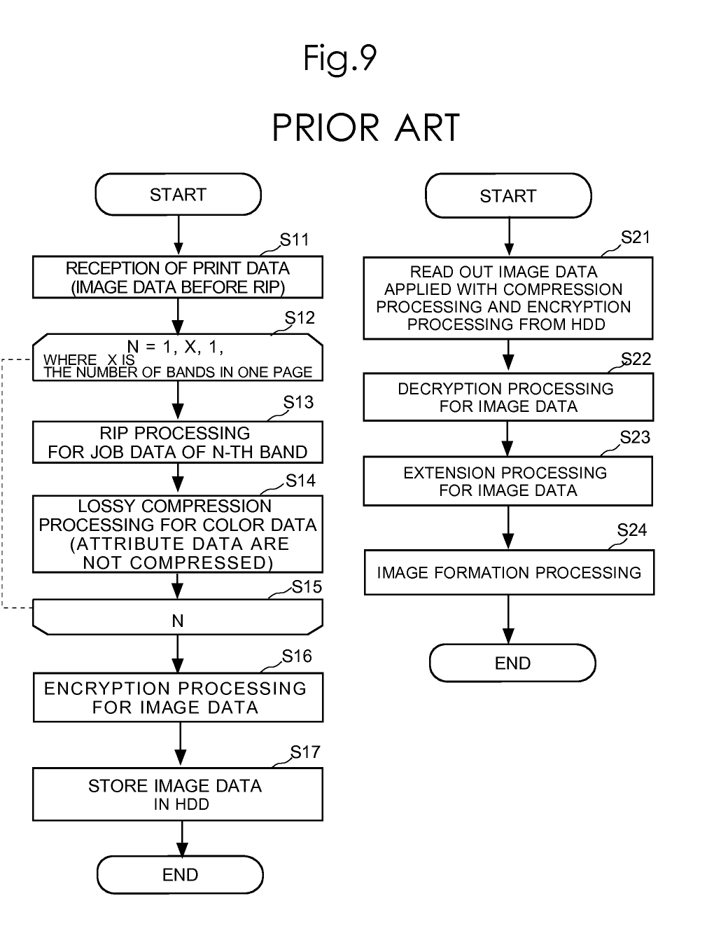

In such a case, the respective steps described in the flow chart shown in FIG. 6 may be modified as shown in FIG. 8. Herein, in FIG. 6 and FIG. 8, the same processing content is attached with the same step number, whereby the duplicate description is omitted. In FIG. 8, the color data group decryption processing and the attribute data decryption processing are omitted. Further, in FIG. 8, the respective contents of other items in the processing and the processing order are the same as those in the case of FIG. 6.

In parallel processing in this case, the color data group read-out processing (Step S202 in FIG. 8) to read out the color data group from the HDD 143 and the attribute data group extension processing (Step S204 in FIG. 8) to losslessly extend the attribute data group by the extending section 136 are executed in parallel to each other such that their respective timings overlap with each other. That is, since all the data (both the color data and the attribute data) do not concentrate on each of the read-out processing and the extension processing, the read-out processing and the extension processing can be executed promptly without any waste. Accordingly, it becomes possible to handle the image data of the dot sequential format at high speed without increasing the cost of hardware.

Further, in processing in this case, the attribute data group read-out processing (Step S201 in FIG. 8) to read out the attribute data group from the HDD 143 and the color data group read-out processing (Step S202 in FIG. 8) to read out the color data group from the HDD 143 are executed such that their respective timings are different from each other. In this way, their respective timings of the two processes of the read-out processing are made different from each other, whereby access to the HDD 143 is dispersed. That is, it becomes possible to solve the problem of rate limiting due to the HDD access concentration which had occurred conventionally. Further, since all the data (both the color data and the attribute data) do not concentrate on the read-out processing, the read-out processing can be executed promptly without any waste. Accordingly, it becomes possible to handle the image data of the dot sequential format at high speed without increasing the cost of hardware.

### Other Embodiments

In the description of each of the above embodiments, while adopting the rule in parallel processing with the same timing or processing with different timings, it is also possible to make modification such as insertion of other processing which is not described here. Also in such a case, each processing can be executed promptly without any waste. Accordingly, it becomes possible to handle the image data of the dot sequential format at high speed without increasing the cost of hardware.

Further, in the above description, the control section 101 in the image forming apparatus 100 is configured to adjust the timing of each processing. The present invention should not be limited to this example. For example, the processing timing may be controlled from external apparatuses via a network.

Further, even in the case where an image processing apparatus exists solely so as to make the image processing section 130 as the center, not as the image forming apparatus 100, similarly to the above-mentioned embodiments, it becomes possible to handle the image data of the dot sequential format at high speed without increasing the cost of hardware.

What is claimed is:

1. An image processing apparatus for processing image data in which color data and attribute data of each pixel are arranged in a dot sequential format, comprising:
an arrangement converting section which separates the color data and the attribute data in the image data and converts arrangement into a face sequential format of a color data group and an attribute data group; and
a compressing section which lossily compresses the color data group and losslessly compresses the attribute data group.

2. The image processing apparatus described in claim 1, further comprising:
a RIP processing section which executes Rip processing for image data not applied with the RIP processing;
wherein the RIP processing section executes the RIP processing in units of a band for the image data which correspond in amount to one page and are divided into multiple bands, and the compressing section repeats lossy compression executed in units of a band for the color data group corresponding in amount to one page and losslessly compresses the attribute data group which is converted in terms of arrangement and corresponds in amount to one page.

3. The image processing apparatus described in claim 1, further comprising:
a storage section which stores data; and
a control section which controls operation of each section;
wherein the control section controls such that color data group storage processing to store the lossily-compressed color data group in the storage section and attribute data group compression processing to losslessly compress the attribute data group by the compressing section are executed in parallel to each other.

4. The image processing apparatus described in claim 1, further comprising:
a storage section which stores data; and
a control section which controls operation of each section;
wherein the control section controls such that color data group storage processing to store the lossily-compressed color data group in the storage section and attribute data group storage processing to store the losslessly-compressed attribute data group in the storage section are executed in respective different timings.

5. The image processing apparatus described in claim 1, further comprising:
a storage section which stores data;
an extending section which lossily extends the lossily-compressed color data group and losslessly extends the losslessly-compressed attribute data group; and
a control section which controls operation of each section;
wherein in the case where the lossily-compressed color data group and the losslessly-compressed attribute data group are stored with a face sequential format in the storage section, the control section controls such that color data group read-out processing to read out the lossily-compressed color data group from the storage section and attribute data group read-out processing to read out the losslessly-compressed attribute data group from the storage section are executed in respective different timings, and the control section controls the arrangement converting section to convert the arrangement of each of the read-out color data group and the read-out attribute data group into a dot sequential format.

6. The image processing apparatus described in claim 1, further comprising:
a storage section which stores data;
an extending section which lossily extends the lossily-compressed color data group and losslessly extends the losslessly-compressed attribute data group; and
a control section which controls operation of each section;
wherein the control section controls such that color data group read-out processing to read out the lossily-compressed color data group from the storage section and attribute data group extension processing to losslessly extend the losslessly-compressed attribute data group read out from the storage section by the extending section are executed in parallel to each other.

7. The image processing apparatus described in claim 1, further comprising:
an encrypting section which encrypts data; and
a control section which controls operation of each section;
wherein the control section controls such that the color data group is encrypted by the encrypting section after having been lossily compressed by the compressing section and the attribute data group is encrypted by the encrypting section after having been losslessly compressed by the compressing section.

8. The image processing apparatus described in claim 7, further comprising:
a decrypting section which decrypts encrypted data;
wherein the control section controls such that the color data group is decrypted by the decrypting section before being lossily extended by the extending section and the attribute data group is decrypted by the decrypting section before being losslessly extended by the extending section.

9. An image forming apparatus, comprising:
the image processing apparatus described in claim 1;
an extending section which lossily extends the lossily-compressed color data group and losslessly extends the losslessly-compressed attribute data group;
a storage section which stores data;
a control section which controls operation of each section; and
an image forming section which forms an image based on image data of a dot sequential format;
wherein the control section controls so as to store lossily-compressed color data group and losslessly-compressed attribute data group with a face sequential format in the storage section,
to read out the color data group and the attribute data group from the storage section,
to lossily extend the read-out color data group by the extending section and losslessly extend the read-out attribute data group by the extending section,
to convert arrangement of each of the lossily-extended color data group and the losslessly-extended attribute data group into a dot sequential format by the arrangement converting section, and
to form an image based on the image data converted in arrangement into the dot sequential format.

10. An image forming apparatus, comprising:
the image processing apparatus described in claim 5, and
an image forming section which forms an image based on image data converted in arrangement into a dot sequential format.

11. An image processing method of processing image data in which color data and attribute data of each pixel are arranged in a dot sequential format, comprising:
an arrangement converting step which separates the color data and the attribute data in the image data and converts arrangement into a face sequential format of a color data group and an attribute data group; and
a compressing step which lossily compresses the color data group and losslessly compresses the attribute data group.

12. The image processing method described in claim 11, further comprising:
a RIP processing step which executes Rip processing for image data not applied with the RIP processing;
wherein the RIP processing step executes the RIP processing in units of a band for the image data which correspond in amount to one page and are divided into multiple bands, and the compressing step repeats lossy compression executed in units of a band for the color data group corresponding in amount to one page and losslessly compresses the attribute data group which is converted in terms of arrangement and corresponds in amount to one page.

13. The image processing method described in claim 11, further comprising:
a storage step which stores data in a storage section;
wherein color data group storage processing to store the lossily-compressed color data group and attribute data group compression processing to losslessly compress the attribute data group are executed in parallel to each other.

14. The image processing method described in claim 11, further comprising:
a storage step which stores data in a storage section;
wherein color data group storage processing to store the lossily-compressed color data group and attribute data group storage processing to store the losslessly-compressed attribute data group are executed in respective different timings.

15. The image processing method described in claim 11, further comprising:
a storage step which stores data in a storage section; and
an extending step which lossily extends the lossily-compressed color data group and losslessly extends the losslessly-compressed attribute data group;
wherein in the case where the lossily-compressed color data group and the losslessly-compressed attribute data group are stored with a face sequential format, color data group read-out processing to read out the lossily-compressed color data group from the storage section and attribute data group read-out processing to read out the losslessly-compressed attribute data group from the storage section are executed in respective different timings, and each of the read-out color data group and the read-out attribute data group is converted in arrangement into a dot sequential format.

16. The image processing method described in claim 11, further comprising:
a storage step which stores data in a storage section; and
an extending step which lossily extends the lossily-compressed color data group and losslessly extends the losslessly-compressed attribute data group;
wherein color data group read-out processing to read out the lossily-compressed color data group from the storage section and attribute data group extension processing to losslessly extend the losslessly-compressed attribute data group read out from the storage section are executed in parallel to each other.

17. The image processing method described in claim 11, further comprising:
an encrypting step which encrypts data;
wherein the color data group is encrypted after having been lossily compressed and the attribute data group is encrypted after having been losslessly compressed.

18. The image processing method described in claim 11, further comprising:
a decrypting step which decrypts encrypted data;
wherein the color data group is decrypted before being lossily extended and the attribute data group is decrypted before being losslessly extended.

19. An image forming method, comprising:
each step of the image processing method described in claim 11;
an extending step which lossily extends the lossily-compressed color data group and losslessly extends the losslessly-compressed attribute data group;
a storage step which stores data in a storage section; and
an image forming step which forms an image based on image data of a dot sequential format;
wherein lossily-compressed color data group and losslessly-compressed attribute data group are stored with a face sequential format, the color data group and the attribute data group are read out from the storage section,
the read-out color data group is lossily extended and the read-out attribute data group is losslessly extended,
each of the lossily-extended color data group and the losslessly-extended attribute data group is converted in arrangement into a dot sequential format, and an image is formed based on the image data converted in arrangement into the dot sequential format.

20. An image forming method, comprising:
each step of the image processing method described in claim 15, and
an image forming step which forms an image based on image data converted in arrangement into a dot sequential format.
